(19) United States
(12) Patent Application Publication
(10) Pub. No.: US 2011/0123733 A1
(43) Pub. Date: May 26, 2011

(54) Vacuum flat glass substrate structure

(76) Inventors: Frank Yang, Guanyin Township (TW); Ming Chun Ho, Pingzhen City (TW); Shih-Chien Hsiao, Guanyin Township (TW); Chuei-Chuan Wang, Guanyin Township (TW)

(21) Appl. No.: 12/591,612

(22) Filed: Nov. 25, 2009

(51) Int. Cl. B32B 3/06; B32B 3/22; E06B 3/00; B32B 17/06; B32B 3/08

(52) U.S. Cl. 428/34

(57) ABSTRACT

A vacuum flat glass substrate structure includes two glass substrates and a glass frit adhering to the boundary of the two glass substrates. The glass substrates and the glass frit form a sealed vacuum room. The two glass substrates have receiving gaps formed on the boundary thereof. A glass tube is disposed in the receiving gaps, and an interior end portion of the glass tube extends into the vacuum room and a sealed exterior end portion of the glass tube doesn't extend out of the geometric space in accordance of the receiving gaps. Accordingly, the present invention can receive and conceal the glass tube protruding out of the surfaces associated with the glass substrates in the receiving gaps, thereby keeping the glass substrates in flat and smooth shape after being lapped and sealed.

### BACKGROUND OF THE INVENTION

1. Field of the Invention

The present invention relates to a vacuum glass substrate, and more particularly to a vacuum flat glass substrate structure manufactured via pumping.

2. Description of Related Art

In a vacuum flat glass substrate technology, two pieces of glass substrates are spaced by proper spacers. A glass frit bonds the boundary of the glass substrates. Gas is pumped from a chamber of the glass substrates by a vacuum pump and getter materials are disposed in the chamber, and the range of the vacuum pressure in the chamber is about 10⁻²˜10⁻⁷ torr. The technology is applied in various vacuum glass assemblies such as FED, VFD, PDP and so on.

There are many methods of manufacturing vacuum glass substrates. The most common method is to pump gas from a chamber by a glass pumping tube, as shown in FIG. 1, the chamber 13, formed by two sheet glasses 11 and a glass frit 12 is connected with a glass pumping tube 14 which protrudes on the upper sheet glass 11. Please refer to FIG. 2, gas can be pumped via the connection of the glass tube 14 and a pumping system. After pumping is done and the vacuum state is achieved, the glass tube 14 is melted and cut off to form an airtight seal.

The airtight method by cutting off the glass pumping tube is to partially heat the glass pumping tube so as to melt the glass tube after pumping is done and the vacuum state is achieved. Because the melting point required for melting glass is very high, the operating location of the glass tube for heating can not be too close to that of the sheet glass to avoid that the sheet glass are heated non-uniformly, and thereby breaking into pieces that is, one segment of the glass tube is kept outside the sheet glass after the glass pumping tube is melted and cut off. Though the aforementioned problem can be overcome based on structure designs in applications, the vacuum glass substrate cannot be completely flattened.

Furthermore, the melting point required in temperature for melting glass is higher than 500° C., so the melted position cannot be too close to the sheet glass. If the melted position is too close to the sheet glass, then the residual thermal stress will act on the position of the sheet glass where the sheet glass is connected with the glass tube. The residual thermal stress will affect the yield rate and service life. Therefore, based on various related experimental validations, it is necessary that the glass tube extends out of the sheet glass.

As shown in FIG. 3, U.S. Pat. No. 5,657,607 discloses that an L-shaped through tube 15′ which is formed in an upper sheet glass 11 and connected with a chamber 13′. The chamber 13′ is connected with a glass tube 14′. Thus, the glass tube 14′ is located on one side of the sheet glass 11′. Though the patent solves the above-mentioned problem that the glass pumping tube extends out of the sheet glass, it is difficult to be manufactured actually. According to the characteristics and the workability of glass, it is difficult to form and fabricate the through tube 15′ in the sheet glass 11′.

Hence, the inventors of the present invention believe that the shortcomings described above are able to be improved and finally suggest the present invention which is of a reasonable design and is an effective improvement based on deep research and thought.

### SUMMARY OF THE INVENTION

An object of the present invention is to provide a vacuum flat glass substrate structure which can be kept in flat and smooth shape completely after being sealed.

To achieve the above-mentioned object, a vacuum flat glass substrate structure in accordance with the present invention is provided. The vacuum glass substrate structure includes two glass substrates and a glass frit. The two glass substrates keep an interval in between. The glass frit adheres to the boundary of the two glass substrates for airtightly bonding the two glass substrates, and the glass frit is low-temperature glass frit applied in a vacuum environment. The two glass substrates and the glass frit form a sealed vacuum room together. The two glass substrates have receiving gaps extending inwards on the boundary thereof. A glass tube is disposed in the receiving gaps, and an interior end portion of the glass tube extends into the vacuum room and an exterior end portion of the glass tube which is sealed doesn't extend out of the geometric space of the receiving gaps.

The efficacy of the present invention is as follows: the present invention precuts the boundary of the glass substrates to form the corresponding receiving gaps for receiving and concealing the glass tube protruding from the surfaces of the glass substrates, so that the vacuum glass substrate structure can be maintained in flat and smooth shape completely after being lapped and sealed.

To further understand technologies, means and efficacy of the present invention, please refer to the following detailed description and drawings related the present invention. The objects, features and advantages of the present invention will become more readily appreciated. However, the drawings are only to be used as references and explanations, not to limit the present invention.

### BRIEF DESCRIPTION OF THE DRAWINGS

FIG. 1 is a structural schematic view of a conventional vacuum glass substrate;

FIG. 2 is a structural schematic view of the conventional vacuum. glass substrate, after being sealed;

FIG. 3 is a structural schematic view of another conventional vacuum glass substrate;

FIG. 4 is a flow chart of the present invention;

FIG. 5 is an exploded perspective view of a first embodiment of a vacuum flat glass substrate structure of the present invention;

FIG. 6 is an assembled perspective view of the first embodiment in accordance with the vacuum flat glass substrate structure of the present invention;

FIG. 7 is a cross-sectional view taken along lines 7-7 in FIG. 6;

FIG. 8 is an assembled perspective view of the first embodiment in accordance with the vacuum flat glass substrate structure of the present invention, showing that a glass tube is in a sealed state;

FIG. 9 is a top view of FIG. 8;

FIG. 10 is a top view of a second embodiment in accordance with the vacuum flat glass substrate structure of the present invention;

FIG. 11 is a top view of a third embodiment in accordance with the vacuum flat glass substrate structure of the present invention;

FIG. 12 is a front view of a fourth embodiment in accordance with the vacuum flat glass substrate structure of the present invention; and

FIG. 13 is a top view in accordance with the vacuum flat glass substrate structure of the present invention, showing that a metal cover board is disposed on the glass substrates.

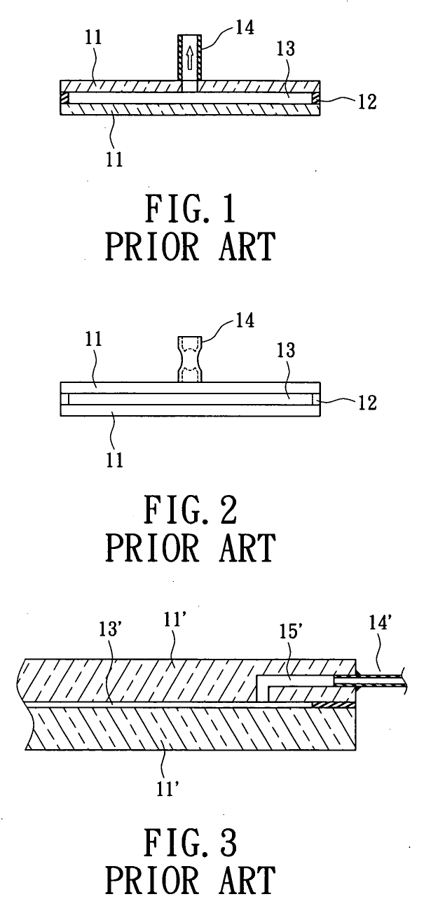

### DETAILED DESCRIPTION OF THE PREFERRED EMBODIMENTS

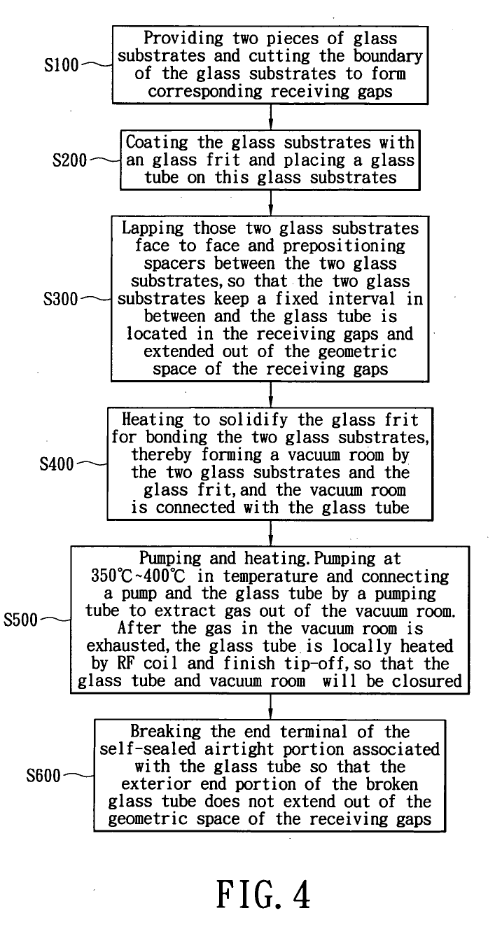

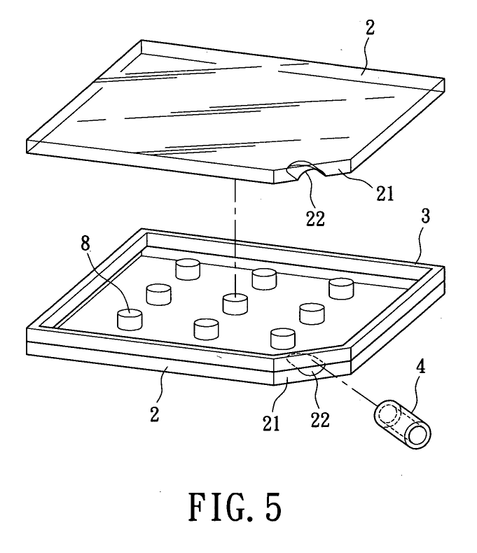

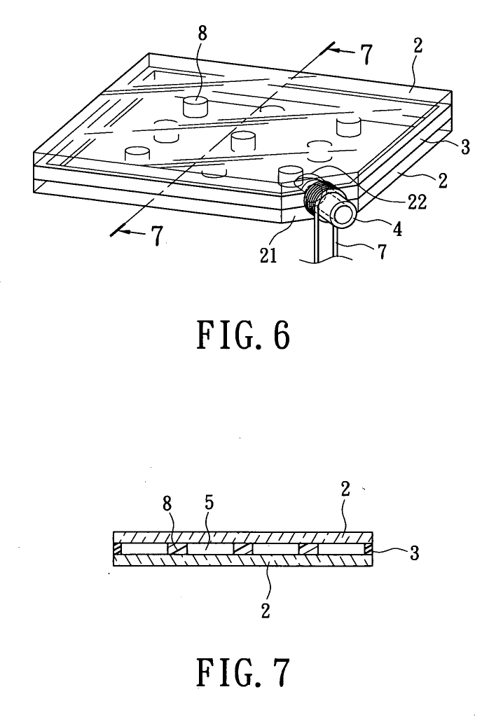

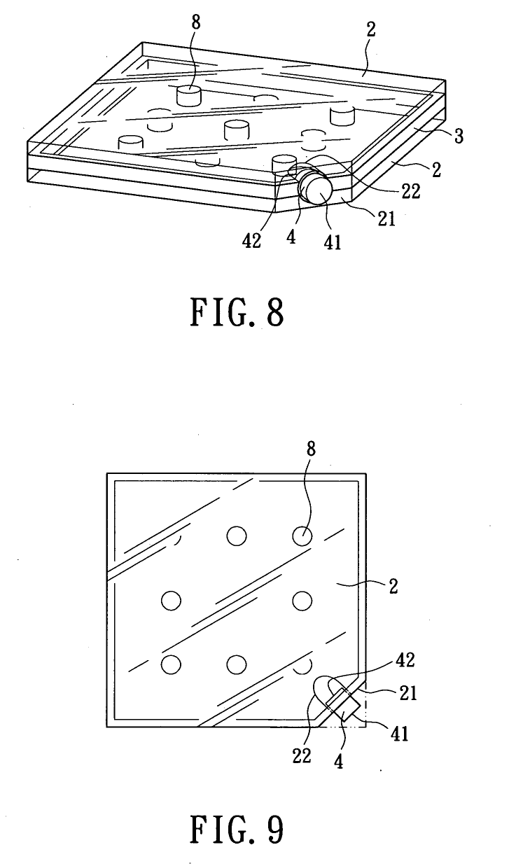

Please refer to FIG. 4 illustrating a vacuum flat glass substrate structure according to the present invention, and please refer to FIGS. 5-9 cooperatively, the vacuum flat glass substrate structure can be manufactured in the steps as follows.

(S100) First, providing two pieces of glass substrates 2 and cutting the boundary of the glass substrates 2 to form corresponding receiving gaps 21 which are concave inwards:

(S200) Coating the boundary of the glass substrates 2 with low-temperature glass frit as a glass frit 3 in a vacuum environment and placing a glass tube 4 on this glass substrates 2.

(S300) Lapping those two glass substrates 2 face to face and prepositioning spacers 8 between the two glass substrates 2, so that the two glass substrates 2 keep a fixed interval in between and the glass tube 4 is located in the receiving gaps 21 and extended out of the geometric space associated with the receiving gaps 21.

(S400) Heating so that the glass frit 3 is solidified to bond the two glass substrates 2, thereby the two glass substrates 2 and the glass frit 3 can form a vacuum room 5 which is connected with the glass tube 4.

Wherein, the glass frit 3 can be heated and solidified under the temperature of 460° C. for 30 minutes.

(S500) Pumping and heating. Pumping under the temperature of 350° C.˜400° C. and connecting a pump (not shown) and the glass tube by a pumping tube to extract gas out of the vacuum room. After the gas in the vacuum room 5 is exhausted, the glass tube 4 is locally heated by RF coil 7 and finish-off, so that the glass tube 4 and vacuum room 5 will be closured.

Wherein, there are various ways of partially heating the glass tube 4, and the present invention primarily applies a micro RF coil 7 which can concentrate the heat source on the intended position of the glass tube 4 as reliable as possible to prevent too much heat from dissipating to the glass substrates 2.

(S600) At last, breaking the end terminal of the self-sealed airtight portion associated with the glass tube 4 so that the exterior end portion 41 of the broken glass tube 4 does not extend out of the geometric space in accordance with the receiving gaps 21. The exterior end portion 41 is sealed and the opposite interior end portion 42 is connected with the vacuum room 5.

In the above-mentioned step of pumping and heating (S500), the preferred heat temperature is at 460° C., and the temperature of partially heating the glass tube 4 via the RF coil 7 is between 600° C. and 700° C.

Based on the above-mentioned manufacturing method, a vacuum flat glass substrate structure which maintains in completely flat and smooth shape can be achieved. That is, the completed vacuum flat glass substrate structure includes the two pieces of glass substrates 2 and the glass frit 3, which form the vacuum room 5 together, wherein the glass substrates 2 have the receiving gaps 21 formed on the boundary thereof. The glass tube 4 is disposed in the receiving gaps 21, the interior end portion 42 of the glass tube 4 is extended into and connected with the vacuum room 5, and the exterior end portion 41 thereof is not extended out of the geometric space in accordance with the receiving gaps 21. Since the exterior end portion 41 of the glass tube 4 which is sealed and then is broken does not extend out of the geometric space in accordance with the receiving gaps 21, it can not protrude from the surfaces of the glass substrates 2, thereby completely flattening the vacuum glass substrate structure.

The related design of the present invention is further described. For example, the two pieces of glass substrates 2 may have the thickness of 1.1 mm-10 mm and the dimensional size of 370 mm*470 mm, and the glass tube 4 may have the outer diameter of 3 mm-10 mm. In the step (S100) of the present invention, further, two corresponding grooves 22 may be formed in the corresponding inner surfaces of the two glass substrates 2, respectively extending inwards for a distance from the inner walls of the receiving gaps 21 which face inwards. In the step of placing the glass tube 4, the interior end portion 42 of the glass tube 4 is placed in the grooves for locating the glass tube 4 and so on; or, an interior end portion of the pumping tube associated with the pump may be positioned in the grooves. However, the geometric space in accordance with the receiving gaps 21, which is formed by cutting the glass substrates 2, is determined by the length of the sealed glass tube 4 which relates to the material, the tube diameter and other parameters of the glass tube 4 (it will be illustrated as follows).

On the other hand, in a modified embodiment of the present invention, the receiving gaps can be formed in different positions surrounding the boundary of the glass substrates. As shown in FIGS. 5-9, cutting off any one of the four edges of each flat glass substrate slantways to form a receiving gap 21, that is, the geometric space of the receiving gap 21 is triangular (as the imaginary line shown in FIG. 9) and the exterior end portion of the glass tube 4 doesn't exceed the vertex of the triangular receiving gap 21. For example, in the embodiment, the glass substrates of 2.8 mm in thickness are selected, the glass tube have the outer diameter of 5 mm, and the value of protrusion in the sealed glass tube is 4 mm for safety design. Accordingly, by applying the Pythagorean Theorem, the leg length of 5.6 mm in longitudinal and transverse direction of each glass substrate is cut off so as to receive and conceal the protrusion of the sealed glass tube of 4 mm entirely in the geometric space associated with the receiving gaps.

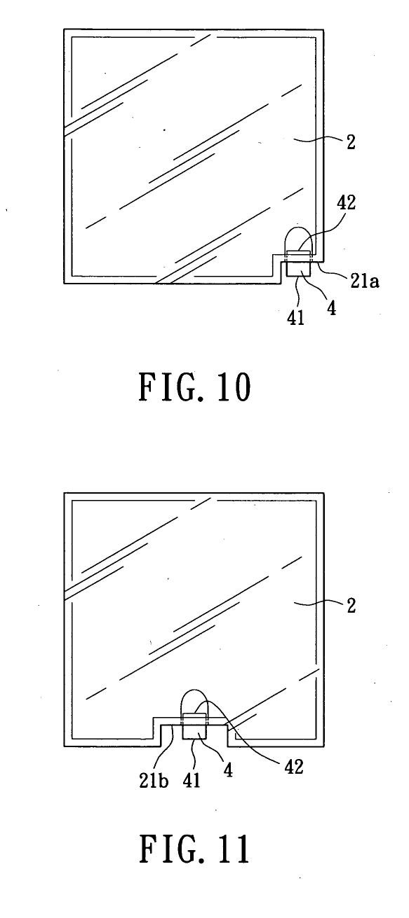

As shown in FIG. 10, a second embodiment is similar to the above-mentioned first embodiment, that is, any one of the four edges of each glass substrate 2 is cut off non-slantways to form one receiving gap 21a. Furthermore, each receiving gap in the two embodiments is formed on any one edge of the corresponding glass substrate 2.

As shown in FIG. 11, in a third embodiment, one receiving gap 21b is formed by cutting the center of one side out of four sides of each glass substrate 2 to dent the center insidewards. Also, similarly to the above-mentioned embodiment, when the embodiment selects the glass tube 4 with the outer diameter of 5 mm, the concave depth of the receiving gap 21b may be 4 mm for receiving the protruding glass tube 4 after being sealed.

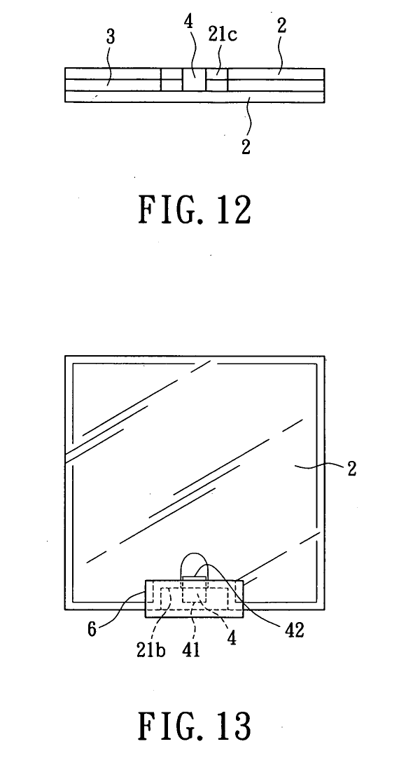

As shown in FIG. 12, in a fourth embodiment, receiving gaps 21c are formed by cutting either the common outer top surface or the common outer bottom surface of the boundary of the two glass substrates 2. The depth may be 4 mm for receiving and concealing the sealed glass tube 4 of which the length of the protrusion is 4 mm.

Further, as shown in FIG. 13, the present invention may have a metal cover board 6 disposed on the two glass substrates 2 for covering the receiving gap 21, thereby protecting the glass substrates 2 and the glass tube 4.

Consequently, the present invention precuts the boundary of the glass substrates to form the receiving gaps with special space for receiving and concealing the glass tube protruding from the surfaces of the glass substrates, so that the vacuum glass substrate structure can be kept in flat and smooth shape completely after being lapped and sealed and can be easily manufactured for the benefit of being applied in various vacuum glass assemblies such as FED, VFD, VIG or PDP etc.

What are disclosed above are only the specification and the drawings of the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A vacuum flat glass substrate structure, comprising:
two glass substrates, keeping an interval in between and having receiving gaps extending inwards on a boundary of the two glass substrates;
a glass tube, disposed in the receiving gaps; and
a glass frit, adhering to the boundary of the two glass substrates, airtightly bonding the two glass substrates, and being low-temperature glass frit in a vacuum circumstance;
wherein the two glass substrates and the glass frit form a sealed vacuum room together, and an interior end portion of the glass tube is extended into and is connected with the vacuum room and an exterior end portion of the glass tube which is sealed doesn't extend out of geometric space in accordance with the receiving gaps.

2. The vacuum flat glass substrate structure as claimed in claim 1, wherein the two glass substrates have corresponding grooves formed in corresponding inner surfaces thereof, and the grooves extend inwards for a distance from inner walls of the receiving gaps which face inwards, the interior end portion of the glass tube or an interior end portion of a pumping tube is disposed in the grooves.

3. The vacuum flat glass substrate structure as claimed in claim 1, wherein each receiving gap is formed in any one edge of four edges of the corresponding glass substrate.

4. The vacuum flat glass substrate structure as claimed in claim 1, wherein each receiving gap is formed in any one side of four sides of the corresponding glass substrate.

5. The vacuum flat glass substrate structure as claimed in claim 1, wherein a metal cover board is disposed on the two glass substrates for covering up the receiving gaps.

6. The vacuum flat glass substrate structure as claimed in claim 1, wherein the receiving gaps are formed by digging either a common outer top surface or a common outer bottom surface of the two glass substrates inwards.
